(19) United States
(12) Patent Application Publication
(10) Pub. No.: US 2019/0377523 A1
(43) Pub. Date: Dec. 12, 2019

(54) PRINTING APPARATUS, CONTROL METHOD, AND STORAGE MEDIUM

(71) Applicant: CANON KABUSHIKI KAISHA, Tokyo (JP)

(72) Inventor: Yasuhiro Takahashi, Abiko-shi (JP)

(21) Appl. No.: 16/428,647

(22) Filed: May 31, 2019

(30) Foreign Application Priority Data
Jun. 8, 2018 (JP) 2018-110669

(51) Int. Cl. G06F 3/12

(52) U.S. Cl. CPC G06F 3/1207; G06F 3/1235; G06F 3/1279

(57) ABSTRACT

A printing apparatus includes a scanner, a printer, a storage, a controller, and a display. The scanner reads a plurality of originals. The printer starts to print images of the originals read by the scanner before the reading of the plurality of originals is completed. The controller selects, from a plurality of printing paper holding units of the printing apparatus, a printing paper holding unit storing printing paper sheets on which the images are to be formed. The display displays an error message in a case where the number of the printing paper sheets held in the selected printing paper holding unit is less than a number of the printing paper sheets necessary to complete the printing of the images of the plurality of read originals.

### BACKGROUND

### Field

The present disclosure relates to a printing apparatus that can perform a display reflecting the number of printing paper sheets stored in a printing paper holding unit of the printing apparatus and the number of printing paper sheets necessary for printing, to a control method of the printing apparatus, and to a storage medium storing a program for the control method.

### Description of the Related Art

In a conventional image forming apparatus such as a copying machine or the like, when paper in a printing paper storage unit runs out during printing of a scanned original or received print data, a screen to urge a user to replenish the printing paper holding unit with paper is displayed on an operation unit, thereby notifying the user of such a fact. However, when the user is notified of a need of a replenishment of paper at a timing when a paper-out condition occurs, the user thereafter has to prepare printing paper for the replenishment, which results in a poor working efficiency. In addition, there can be a case where printing has been interrupted due to paper-out condition when a user comes to a copying machine to take a product expecting that the printing has been finished.

Japanese Patent Application Laid-Open No. 2000-211772 discloses a method used in printing using a printer driver in which the number of printing paper sheets held in a printing paper holding unit of a copying machine is acquired in advance, and when the number falls below the number necessary for the printing, a user is notified of a shortage of printing paper.

However, although disclosing the printing using the printer driver (hereafter, referred to as PDL (page description language) printing), Japanese Patent Application Laid-Open No. 2000-211772 does not disclose printing a scanned original (hereafter, referred to as copying).

The copying differs from the PDL printing in a timing at which the number of the printing paper sheets necessary for the printing is found. More specifically, in the PDL printing, the printer driver knows the number of pages of print data before giving a printing instruction to a copying machine. Therefore, by comparison of the number with the number of the printing paper sheets in a printing paper holding unit, a user can be notified in advance of whether a paper-out condition will occur. However, this does not address issues related to the copying.

### SUMMARY

In the copying, how many printing paper sheets will be necessary for printing can be determined only after all originals have been scanned. This requires countermeasures according to an idea different from that of PDL printing. In this regard, the present disclosure relates to displaying an error indicating a paper-out condition immediately in the middle of a process of printing images of originals read by a scanner.

According to an aspect of the present disclosure, printing apparatus includes a scanner configured to read a plurality of originals, a printer configured to start to print images of the originals read by the scanner before the reading of the plurality of originals is completed, a controller configured to select, from a plurality of printing paper holding units of the printing apparatus, a printing paper holding unit storing printing paper sheets on which the images are to be formed, and a display configured to display an error message in a case where the number of the printing paper sheets held in the selected printing paper holding unit is less than a number of the printing paper sheets necessary to complete the printing of the images of the plurality of read originals.

Further features of the present disclosure will become apparent from the following description of exemplary embodiments with reference to the attached drawings.

### BRIEF DESCRIPTION OF THE DRAWINGS

FIG. 1 is a block diagram illustrating a schematic constitution of an image forming apparatus according to an embodiment of the present disclosure.

FIG. 2 is an external view of the image forming apparatus.

FIG. 3 is a flowchart used for describing a copy process in Embodiment 1.

FIG. 4 is an example of a screen in Embodiment 1 notifying a user that a replenishment of printing paper is not needed.

FIG. 5 is an example of a screen in Embodiment 1 notifying a user that a replenishment of printing paper is needed.

FIG. 6 is a flowchart used for describing a copy process in Embodiment 2.

FIG. 7 is an example of a screen in Embodiment 2 notifying a user that a replenishment of printing paper is not needed.

FIG. 8 is an example of a screen in Embodiment 2 notifying a user that a replenishment of printing paper is needed.

### DESCRIPTION OF THE EMBODIMENTS

Hereafter, embodiments for carrying out the present disclosure will be described below in detail as an example with reference to the accompanying drawings. Note that constituent components described in the embodiments should not be construed as limiting on the scope of the present disclosure thereto but rather as illustrative only.

As examples of an image forming apparatus, the following embodiments describe examples of applying the present disclosure to an image forming apparatus having a copying function, such as a copying machine and a printer.

### Embodiment 1

Embodiment 1 of the present disclosure will be described below with reference to the drawings.

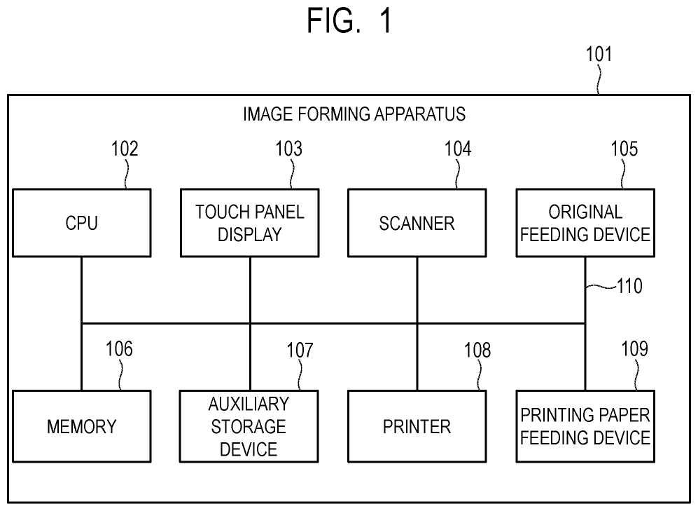

FIG. 1 is a block diagram illustrating a schematic constitution of an image forming apparatus according to Embodiment 1 of the present disclosure. An image forming apparatus 101 includes a central processing unit (hereafter, referred as to a “CPU”) 102, a touch panel display 103, a scanner 104, an original feeding device 105, a printer 108, a printing paper feeding device 109, a memory 106, and an auxiliary storage device 107. These constituent components are connected to one another by an internal bus 110.

The CPU 102 is configured to execute a program expanded in the memory 106 and to control various kinds of devices in the image forming apparatus 101. The touch panel display (operation unit) 103 as a notification unit or a display unit can display a screen to provide information such as a message to a user and can display a screen to receive a key input by a user, that is, a screen to allow the user to input an instruction. The scanner 104 is configured to irradiate an original with light using a light source and to form a reflected image on a solid-state image sensor using lenses. The solid-state image sensor generates a read image signal having a predetermined resolution (e.g., 600 dpi) and a predetermined density level (e.g., 8 bits) and forms, from the read image signal, a scanned image that is made up of raster data. The original feeding device 105 is configured to convey an original to the scanner 104.

The printer 108 is configured to function as an image forming unit that prints a scanned image expanded in the memory 106 onto a printing paper. The printing paper feeding device 109 is configured to convey a printing paper sheet to the printer 108. The memory 106 is configured to serve as a place for expanding a program to be executed by the CPU 102 and configured to hold data to be used by a program. The auxiliary storage device 107 is made up of a mass storage device such as a hard disk drive and configured to save a scanned image and hold an application program to be executed by the image forming apparatus 101. The CPU 102 is configured to expand such an application program into the memory 106 and executes the application program.

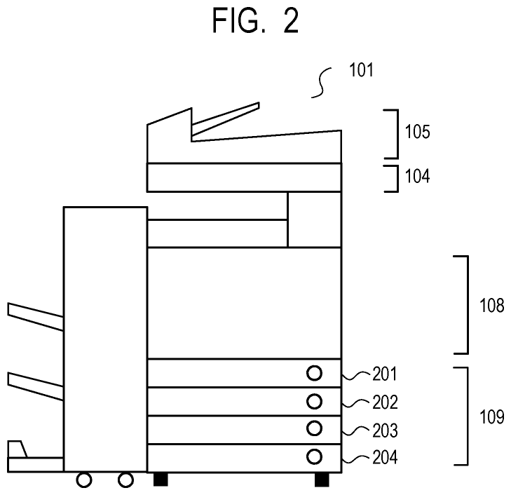

FIG. 2 is an external view of the image forming apparatus 101. In the image forming apparatus 101, the scanner 104 is disposed above the printer 108. The printing paper feeding device 109 includes printing paper holding units (hereafter, referred to as “paper feeding cassettes”) 1 to 4 (201 to 204) each of which is configured to hold up to a predetermined number of, for example 500, printing paper sheets. The numbers of the printing paper sheets held by the paper feeding cassettes (hereafter, referred to also as “remaining printing paper amount”) are measured and managed by the CPU 102 according to a method described below.

<Method for Measuring a Remaining Printing Paper Amount>

An example of a method for measuring remaining printing paper amounts in the paper feeding cassettes 201 to 204 will be described.

For each of the paper feeding cassettes 201 to 204, the CPU 102 determines that the paper feeding cassette is fully loaded with printing paper when a sensor (not illustrated) included in the paper feeding cassette detects that the predetermined number of the printing paper sheets are loaded. That is, in this case, when the sensor detects that 500 printing paper sheets are loaded on a paper feeding cassette, 201 for example, configured to accommodate 500 printing paper sheets, the CPU 102 determines that the paper feeding cassette 201 is fully loaded with printing paper. The CPU 102 stores information indicating that the 500 printing paper sheets are present in the paper feeding cassette 201, in the auxiliary storage device 107.

Thereafter, for each of the paper feeding cassettes, every time printing paper is discharged from the paper feeding cassette, the CPU 102 subtracts the number of the discharged printing paper sheets from the number of the printing paper sheets indicated by the information on the corresponding paper feeding cassette stored in the auxiliary storage device 107. For example, in a case where 20 printing paper sheets are discharged from the paper feeding cassette 201, information indicating that there are 480 printing paper sheets are present in the paper feeding cassette 201 is stored in the auxiliary storage device 107.

The CPU 102 grasps in this manner the information on the number of the printing paper sheets present in each of the paper feeding cassettes.

<Copy Process Using Remaining Printing Paper Amount>

Next, a copy process using a remaining printing paper amount according to the present embodiment will be described. Here, to describe details of the process specifically, it is assumed that information on an original, copy settings set by a user, and statuses of the paper feeding cassettes are as given in Table 1 to Table 3. The copy settings include a setting for scanning the original, a setting for printing on printing paper, an instruction of image arrangement on printing paper such as page layout (arranging multiple originals on a single printing paper sheet), and a setting for the number of copies.

TABLE 1

| Original size | A4 |
|---|---|
| Number of originals | 20 |

TABLE 2

| Scan setting | Single-sided scan |
|---|---|
| Print setting | Single-sided print |
| Number of copies | 5 |

TABLE 3

| | | Remaining sheet |
|---|---|---|
| Paper feeding cassette | Sheet size | amount |
| Paper feeding cassette 1 (201) | A4 | 120 |
| Paper feeding cassette 2 (202) | A4 | 500 |
| Paper feeding cassette 3 (203) | A3 | 200 |
| Paper feeding cassette 4 (204) | — | 0 |

A status of the paper feeding cassette illustrated in Table 3 will be additionally described with reference to the paper feeding cassette 1 (201) and the paper feeding cassette 4 (204) as an example. A size of printing paper held in the paper feeding cassette 1 (201) is A4, and its remaining printing paper amount is 120. The remaining printing paper amount is measured by the CPU 102. In contrast, the remaining printing paper amount of the paper feeding cassette 4 (204) is “0”, which indicates that the paper feeding cassette 4 holds no printing paper sheets.

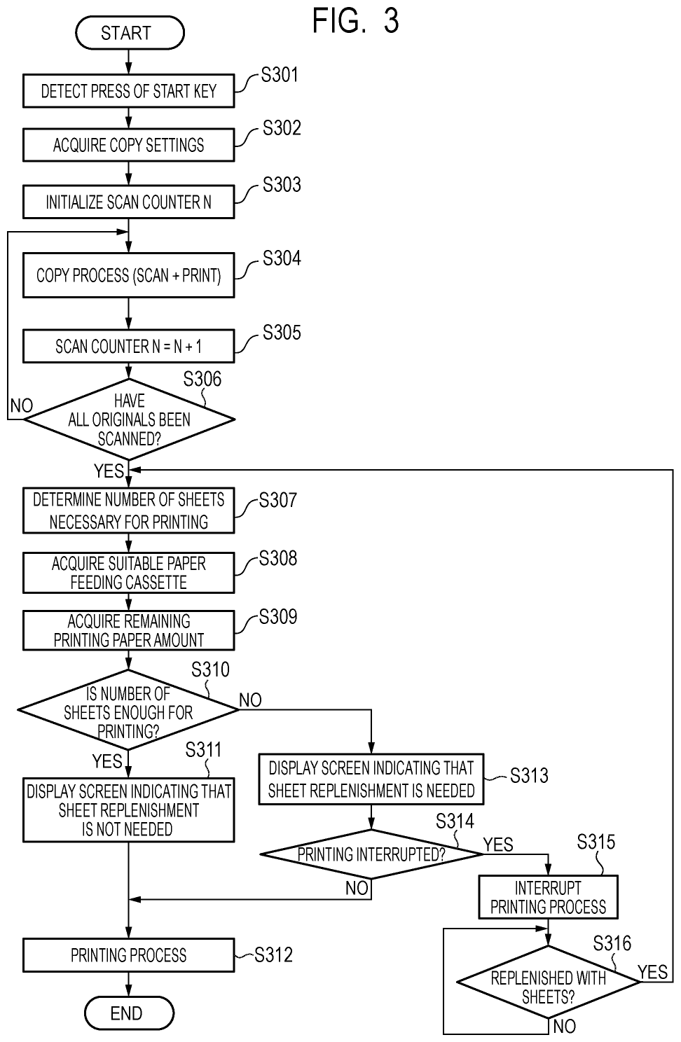

Next, a copy process with the settings given in the above Table 1 to Table 3 will be described with reference to the flowchart illustrated in FIG. 3. The program according to this flowchart that is to run on the image forming apparatus 101 is stored in, for example, the auxiliary storage device 107 illustrated in FIG. 1, read and expanded into the memory 106, and executed by the CPU 102. This holds true for the other flowcharts to be described later. In addition, reference character S indicates a step in the following description.

Here, a case where a user puts a user 20 A4-sized originals in the original feeding device 105, sets five as the number of the copies using the touch panel display 103, and presses a copy start key will be described.

Upon detecting via the touch panel display 103 that the copy start key is pressed (S301), the CPU 102 starts the copy process. In S302, the CPU 102 acquires the copy settings set by the user (equivalent to the settings given in Table 2). In S303, the CPU 102 initializes a scan counter N used for counting the number of times of scans to “0”.

Next, in S304, the CPU 102 instructs the scanner 104 to scan the originals and instructs the printer 108 to print scanned images acquired by the scanner 104 onto printing paper sheets. In this example, since the size of the original is A4, the CPU 102 determines that the paper feeding cassette 1 (201) holding printing paper of the same size is a paper feeding cassette suitable for the printing, and instructs the printing paper feeding device 109 to convey printing paper to the printer 108.

At this point, the paper feeding cassette 2 (202) holds printing paper of the A4 size and therefore may be the suitable paper feeding cassette. However, as compared with the paper feeding cassette 1 (201), a paper conveying path from the paper feeding cassette 2 (202) to the printer 108 is slightly long, and the CPU 102 therefore selects the paper feeding cassette 1 preferentially. Every time a printing paper sheet from the paper feeding cassette 1 (201) is subjected to the printing, the CPU 102 subtracts “1” from the number of the printing paper sheets in the paper feeding cassette 1 (201) stored in the auxiliary storage device 107.

In S305, every time the scanner 104 scans an original, the CPU 102 increment the scan counter N by “1”. In S306, when determining that all the originals have been scanned, the CPU 102 advances the process to S307. Typically, a speed of reading an original by the scanner 104 is higher than a printing speed of the printer 108, and it is therefore often the case that a printing process is still underway when scanning of all originals is finished. In this example, since the number of the copies is set at five, the printing process is still underway also in this case when scanning of all the originals is finished.

In S307, the CPU 102 calculates the number of the printing paper sheets necessary for the printing. In copying, the number of the printing paper sheets necessary for the printing can be determined when the scanning of all the originals is finished and the scan counter N is determined. In this example, since Table 1 and Table 2 show the settings including the number of the originals being 20 and the number of the copies being 5, the number of sheets necessary for the printing is 100. In a case where double-sided printing is set in the setting given in Table 2, the number of the sheets necessary for the printing is halved, 50.

Subtracting the number of the printing paper sheets already subjected to the printing from the number of the sheets necessary for the printing, 100, the CPU 102 calculates the number of sheets necessary for the rest of the printing and determines the number as the number of sheets necessary for printing. As described earlier in S304, the number of the printing paper sheets already subjected to the printing is acquired as the number resulting from the subtraction from the number of the printing paper sheets in the paper feeding cassette 1 (201) stored in the auxiliary storage device 107. Accordingly, for example, when 10 printing paper sheets are already subjected to the printing, 90 (=100-10) is the number of sheets necessary for the rest of the printing.

Next, in S308, the CPU 102 determines one or more paper feeding cassettes suitable for the printing from among the paper feeding cassettes 201 to 204 of the printing paper feeding device 109. That is, the CPU 102 can select one or more paper feeding cassettes suitable for the printing from among the paper feeding cassettes 201 to 204 of the printing paper feeding device 109. In this example, the CPU 102 determines the paper feeding cassette 1 (201) and the paper feeding cassette 2 (202) holding printing paper of the A4 size, the same as the size of the originals, as the paper feeding cassettes suitable for the printing.

Next, in S309, the CPU 102 calculates the total number of the printing paper sheets (total remaining printing paper amount) held in the suitable paper feeding cassettes, which are acquired in S308. In this example, since ten sheets have already been subjected to the printing from the paper feeding cassette 1 (201), a current state of the remaining printing paper amounts is a state given in Table 4 shown below. That is, from Table 4, the total remaining printing paper amount of the paper feeding cassette 1 (201) and the paper feeding cassette 2 (202) is 610.

TABLE 4

| | | Remaining |
|---|---|---|
| Paper feeding cassette | Sheet size | sheet amount |
| Paper feeding cassette 1(201) | A4 | 110 |
| Paper feeding cassette 2(202) | A4 | 500 |
| Paper feeding cassette 3(203) | A3 | 200 |
| Paper feeding cassette 4(204) | — | 0 |

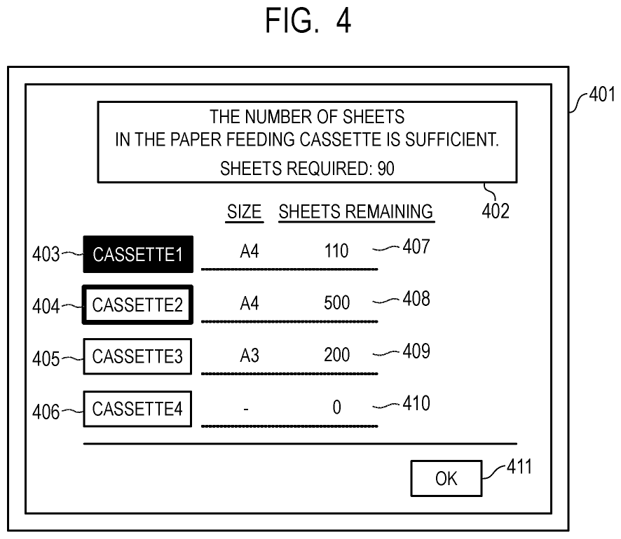

Next, in S310, the CPU 102 compares the number of sheets necessary for printing determined in S307 with the total remaining printing paper amount of the suitable paper feeding cassettes calculated in S309. In a case where the result of the comparison shows that the total remaining printing paper amount of the suitable paper feeding cassettes is more than the number of sheets necessary for printing, the CPU 102 advances the process to S311, causing the touch panel display 103 to display a screen 401 notifying the user that a replenishment of printing paper is not needed, as illustrated in FIG. 4. In the screen 401, an area 402 having a display indicating that the number of sheets in the paper feeding cassettes is sufficient to perform the printing, areas 403 to 410 indicating the statuses of the paper feeding cassettes, and an OK button 411 to close the screen 401.

The areas 403 and 407 indicate the status of the paper feeding cassette 1 (201), the areas 404 and 408 indicate the status of the paper feeding cassette 2 (202), the areas 405 and 409 indicate the status of the paper feeding cassette 3 (203), and the areas 406 and 410 indicate the status of the paper feeding cassette 4 (204).

The display of the statuses of the paper feeding cassettes will be described more in detail. The area 403 has an inverted display, which indicates that the corresponding paper feeding cassette is a paper feeding cassette feeding sheets currently, and the area 404 has a thick-bordered box, which indicates that the corresponding paper feeding cassette is not feeding sheets but is a paper feeding cassette suitable for the printing. Additionally, the areas 407 to 410 display the sizes of printing paper held in the paper feeding cassettes 1 (201) to 4 (204) and the remaining printing paper amounts measured by the CPU 102, respectively. Finishing S311, the CPU 102 advances the process to S312 to perform the rest of the printing process, and when finishing the printing of all the originals, CPU 102 finishes the copy process.

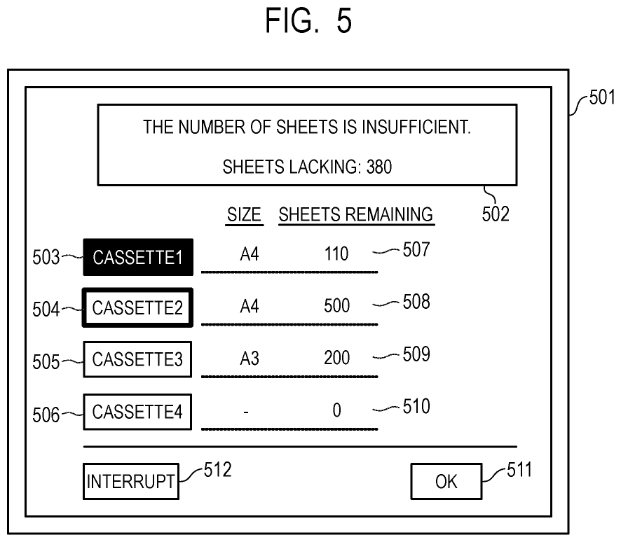

In a case where the total remaining printing paper amount of the suitable paper feeding cassettes is less than the number of sheets necessary for printing in S310, the CPU 102 advances the process to S313. In S313, the CPU 102 causes the touch panel display 103 to display a screen 501 notifying the user that a replenishment of printing paper is needed, as illustrated in FIG. 5. Here, it is assumed for the convenience of the description that the copy settings are as given in Table 5 shown below. A single difference of the copy settings in Table 5 from the copy settings in Table 2 is in that the number of the copies is 50. Setting 50 as the number of the copies here is to describe a case of a shortage of printing paper.

TABLE 5

| Scan setting | Single-sided scan |
|---|---|
| Print setting | Single-sided print |
| Number of copies | 50 |

In the case of Table 5, the number of sheets necessary for the printing is 1000. Then, the total of the remaining printing paper amounts of the paper feeding cassette 1 and the paper feeding cassette 2 selected by the CPU 102, 610, is insufficient to finish the printing, and therefore, the CPU 102 displays a screen 501. In the screen 501, an area 502 having a display indicating a shortage of printing paper sheets in the paper feeding cassettes, areas 503 to 510 indicating the statuses of the paper feeding cassettes, an interrupting button 512 to interrupt the printing process, and an OK button 511 to close the screen 501 are disposed. A user can select either of the OK button 511 and the interrupting button 512 selectively.

The areas 503 and 507 indicate the status of the paper feeding cassette 1 (201), the areas 504 and 508 indicate the status of the paper feeding cassette 2 (202), the areas 505 and 509 indicate the status of the paper feeding cassette 3 (203), and the areas 506 and 510 indicate the status of the paper feeding cassette 4 (204).

The display of the statuses of the paper feeding cassettes is the same as the display in the screen 401 and will not be described. The interrupting button 512 is a button to interrupt the printing process being in action, allowing the user to perform a replenishment of printing paper.

In S314, upon detecting that the interrupting button 512 is pressed by the user, the CPU 102 advances the process to S315, interrupting the printing process in action. Next, the CPU 102 advances the process to S316, waiting for the user to perform the replenishment. Upon detecting that the user performs the replenishment of paper, the CPU 102 advances the process to S307, restarting the process from recalculation of the number of the printing paper sheets necessary for the printing.

The present embodiment is based on the premise that the replenishment of printing paper involves the interruption of the printing process. However, with a constitution in which a paper feeding cassette can be replenished with printing paper without the interruption of the printing process as long as the replenishment does not affect the conveyance of printing paper, the replenishment of printing paper may be performed during the printing process.

In contrast, upon detecting that the OK button 511 is pressed by the user in S314, the CPU 102 advances the process to S312, continuing the printing process without an interruption, which will however bring about a paper-out condition in the middle of the printing process. A conventional technique for the paper-out condition can be adopted in this case and therefore will not be described, but the operation of the process is roughly as follows.

That is, upon detecting that a remaining amount of printing paper in the paper feeding cassettes suitable for the printing (in this example, the paper feeding cassette 1 and the paper feeding cassette 2) is “0”, the CPU 102 instructs the printer 108 to interrupt the printing process.

Then, upon detecting that the user replenishes the paper feeding cassettes with printing paper, the CPU 102 instructs the printer 108 to restart the printing process, and when finishing the printing of all the originals, the CPU 102 finishes the copy process.

As described above, according to the present embodiment, a user can be notified immediately of whether a replenishment of printing paper is necessary before an occurrence of a paper-out condition in a copy process using a scanner. That is, whether a replenishment of printing paper is necessary is displayed at a timing when a scan is finished and the number of the printing paper sheets necessary for printing is determined. Therefore, at the time when the scan is finished, the user can prepare printing paper for the replenishment during the printing, as necessary. In addition, when it turns out that no replenishment of printing paper will occur, the user is allowed to leave the image forming apparatus, and to perform another task until the printing is finished. In the present embodiment, printing is started before the number of the printing paper sheets necessary for the printing is determined, that is, before scanning of all originals is finished. In other words, the printing of image data onto printing paper can be performed in concurrent with an operation of the scan by the scanner, which therefore allows the entire copy process to be finished swiftly.

### Embodiment 2

In Embodiment 1, the case where the printing is started before the number of the printing paper sheets necessary for the printing is determined, that is, before scanning of all originals is finished, is described. This is to avoid a situation where delaying the start of the printing process until the determination of the number of the printing paper sheets necessary for the printing delays the entire copy process accordingly.

However, in a case where the CPU 102 determines that starting the printing process earlier will cause printing paper to run out during the printing process, the printing process has to be interrupted for a replenishment of printing paper and has to be restarted after the replenishment of printing paper. When this interruption and restart is performed smoothly, issues may not arise, but some printers do not allow an immediate restart, which may cause a long downtime. Hence, the present embodiment is configured to start a printing process after the determination of the number of the printing paper sheets necessary for the printing.

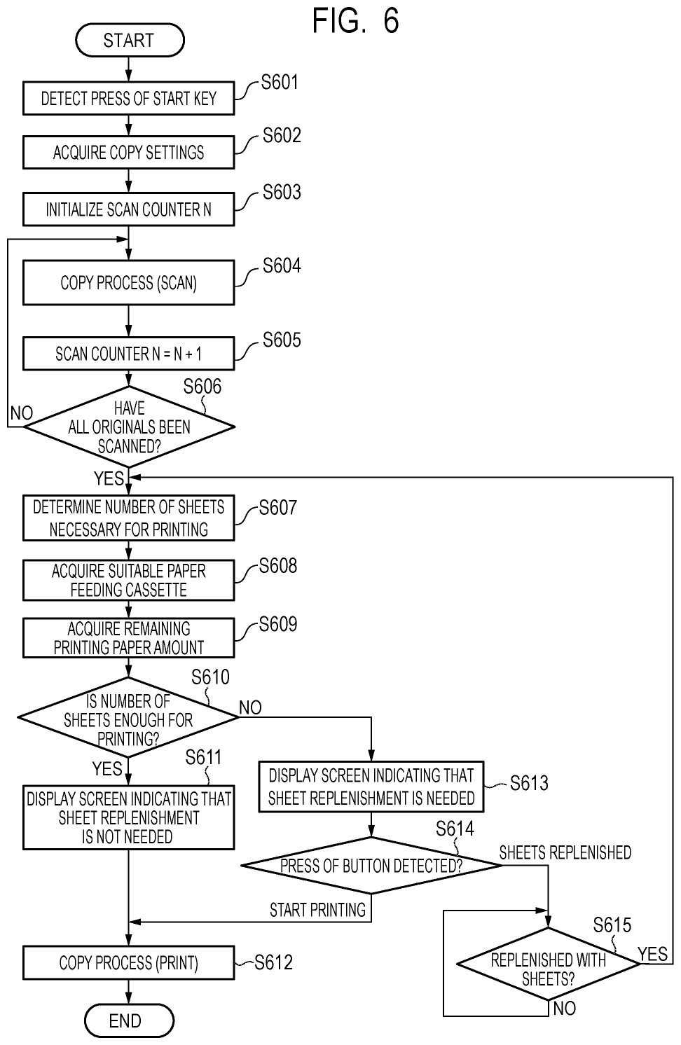

A copy process using a remaining printing paper amount according to the present embodiment will be described with reference to a flowchart illustrated in FIG. 6. The constitution of the image forming apparatus 101 in the present embodiment is the same as the constitution in Embodiment 1. In addition, to describe details of the process specifically, it is assumed that information on an original, copy settings set by a user, and statuses of the paper feeding cassettes are the same as given in Table 1 to Table 3.

A user puts a user 20 A4-sized originals in the original feeding device 105, sets the number of the copies (five copies) using the touch panel display 103, and presses the copy start key. Upon detecting via the touch panel display 103 that the copy start key is pressed (S601), the CPU 102 starts the copy process. In S602, the CPU 102 acquires the copy settings set by the user (equivalent to the settings given in Table 2).

In S603, the CPU 102 initializes a scan counter N used for counting the number of times of scans to “0”. Next, in S604, the CPU 102 instructs the scanner 104 to scan the originals. In S605, every time the scanner 104 scans an original, the CPU 102 increment the scan counter N by “1”. In S606, when determining that all the originals have been scanned, the CPU 102 advances the process to S607.

In S607, the CPU 102 calculates the number of the printing paper sheets necessary for the printing. In this example, as in the above embodiment, since Table 1 and Table 2 show the settings including the number of the originals being 20 and the number of the copies being 5, the number of the printing paper sheets necessary for the printing is 100. Next, in S608, the CPU 102 determines all paper feeding cassettes suitable for the printing from among the paper feeding cassettes 201 to 204 of the printing paper feeding device 109. In this example, the paper feeding cassette 1 (201) and the paper feeding cassette 2 (202) holding printing paper of the A4 size, the same as the size of the originals, are determined as the paper feeding cassettes suitable for the printing.

Next, in S609, the CPU 102 calculates the total number of the printing paper sheets (total remaining printing paper amount) held in the suitable paper feeding cassettes, which are acquired in S608. In this example, from Table 3, the total remaining printing paper amount of the paper feeding cassette 1 (201) and the paper feeding cassette 2 (202) is 620. Next, in S610, the CPU 102 compares the number of the printing paper sheets necessary for printing determined in S607 with the total remaining printing paper amount of the suitable paper feeding cassettes, which is a result of the calculation performed in S609.

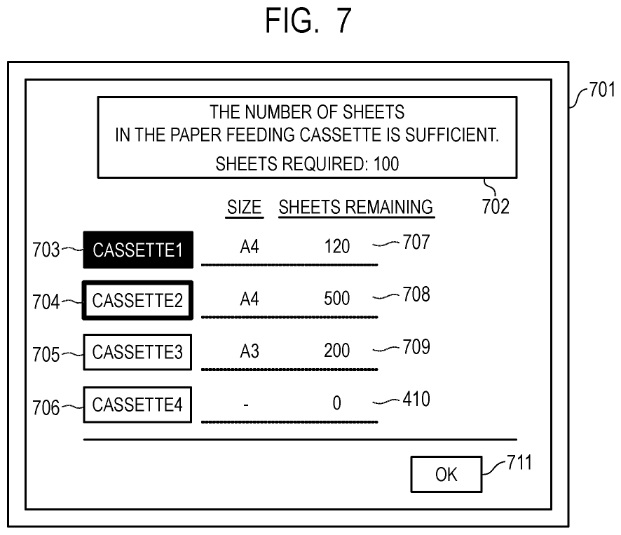

In a case where the total remaining printing paper amount of the suitable paper feeding cassettes is more than the number of the printing paper sheets necessary for printing, the CPU 102 advances the process to S611, causing the touch panel display 103 to display a screen 701 notifying the user that a replenishment of printing paper is not needed, as illustrated in FIG. 7. In the screen 701, an area 702 having a display indicating that the number of the printing paper sheets in the paper feeding cassettes is sufficient to perform the printing, areas 703 to 710 indicating the statuses of the paper feeding cassettes, and an OK button 711 to close the screen 701.

The areas 703 and 707 indicate the status of the paper feeding cassette 1 (201), the areas 704 and 708 indicate the status of the paper feeding cassette 2 (202), the areas 705 and 709 indicate the status of the paper feeding cassette 3 (203), and the areas 706 and 710 indicate the status of the paper feeding cassette 4 (204).

A difference of the screen 701 from the screen 401 illustrated in FIG. 4 in Embodiment 1 is that the printing process is not started yet in this stage. Therefore, the number of the printing paper sheets necessary for the printing displayed in the area 702 is still 100, and the remaining printing paper amount of the paper feeding cassette 1 indicated in the area 707 is still 120. Upon detecting that the OK button 711 is pressed by the user, the CPU 102 advances the process to S612, instructing the printer 108 to perform the printing process. Then, when the printing process for all the originals is finished, CPU 102 finishes the copy process.

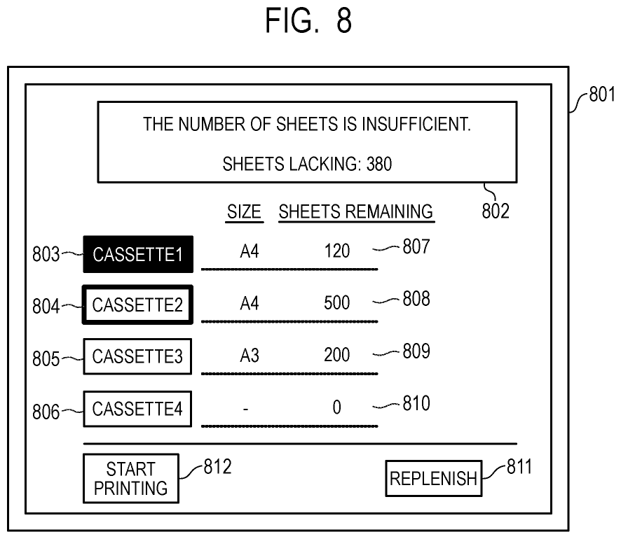

In contrast, in a case where the total remaining printing paper amount of the suitable paper feeding cassettes is less than the number of the printing paper sheets necessary for printing in S610, the CPU 102 advances the process to S613. In S613, the CPU 102 causes the touch panel display 103 to display a screen 801 notifying the user that a replenishment of printing paper is needed, as illustrated in FIG. 8. Here, it is assumed for the convenience of the description that the copy settings are as given in Table 5 shown above in Embodiment 1. In this case, the number of the printing paper sheets necessary for the printing is 1000.

Then, the total of the remaining printing paper amounts of the paper feeding cassette 1 and the paper feeding cassette 2 selected by the CPU 102, 620, is insufficient to finish the printing, and therefore, the CPU 102 displays a screen 801. In the screen 801, an area 802 having a display indicating a shortage of printing paper sheets in the paper feeding cassettes, areas 803 to 810 indicating the statuses of the paper feeding cassettes, a printing start button 812 to start the printing process, and a printing paper replenishment button 811 to allow the user to perform a replenishment of printing paper are disposed.

The areas 803 and 807 indicate the status of the paper feeding cassette 1 (201), the areas 804 and 808 indicate the status of the paper feeding cassette 2 (202), the areas 805 and 809 indicate the status of the paper feeding cassette 3 (203), and the areas 806 and 810 indicate the status of the paper feeding cassette 4 (204).

A difference of the screen 801 from the screen 501 illustrated in FIG. 5 in Embodiment 1 is that the remaining printing paper amount of the paper feeding cassette 1 displayed in the area 807 is still 120 since the printing process is not started yet. Another difference from the screen 501 illustrated in FIG. 5 is that the printing start button 812 to start the printing process and the printing paper replenishment button 811 to allow the user to perform a replenishment of printing paper are disposed.

Next, In S614, upon detecting that the printing start button 812 or the printing paper replenishment button 811 is pressed by the user, the CPU 102 switches between processes to be performed next according to the pressed button. Upon detecting that the printing paper replenishment button 811 is pressed, the CPU 102 advances the process to S615, waiting for the user to perform the replenishment. Upon detecting that the user performs the replenishment of paper, the CPU 102 advances the process to S607, restarting the process from recalculation of the number of the printing paper sheets necessary for the printing.

In contrast, upon detecting that the printing start button 812 is pressed by the user in S614, the CPU 102 advances the process to S612, instructing the printer 108 to start the printing process, but a paper-out condition occurs in the middle of the printing process. A process for the paper-out condition in this case is the same as the process described in Embodiment 1 above and will not be described. When the paper-out condition is eliminated and when the printing of all the originals is finished, the copy process is finished.

According to the present embodiment, as in Embodiment 1, a user can be immediately notified of whether a replenishment of printing paper is necessary before an occurrence of a paper-out condition in a copy process using a scanner. That is, whether a replenishment of printing paper is necessary is displayed at a timing when a scan is finished and the number of the printing paper sheets necessary for printing is determined. Therefore, at the time when the scan is finished, the user can prepare printing paper for the replenishment during the printing, as necessary. In addition, when it turns out that no replenishment of printing paper will occur, the user is allowed to leave the image forming apparatus, and to perform another task until the printing is finished. In the present embodiment, whether a replenishment of printing paper is necessary is displayed at a time when a scan is finished, and the printing is thereafter started. Therefore, a replenishment of printing paper can be prevented from occurring during the printing as in Embodiment 1.

In the above embodiments, a display of a replenishment of printing paper may be performed only when the replenishment becomes necessary or at least in a case where the replenishment is sought. In this case, a replenishment of printing paper can be determined to be unnecessary when no display is made at a time when the scan is finished.

As described above, according to the present disclosure, the image forming apparatus includes an image forming unit (108) configured to print image data acquired from the scanner onto printing paper and a display unit (103) configured to display a message. The image forming apparatus further includes a management unit (the CPU 102, S309, S609), a selection unit (the CPU 102, S308, S608), and a control unit (the CPU 102, S307 to S310, S313, S607 to S610, S613). The management unit is configured to manage the numbers of the printing paper sheets stored in the plurality of printing paper holding units (201 to 204), and the selection unit is configured to select one or more printing paper holding units in which printing paper suitable for printing the image data is stored. The control unit is configured to display on the display unit a message indicating that a replenishment of printing paper is needed in the case where the number of the printing paper sheets held in a printing paper holding unit selected by the selection unit is less than the number of the printing paper sheets necessary that is calculated after all image data items are acquired by the scanner (S313).

The present disclosure can exert effects that include allowing a user to be notified immediately of whether a replenishment of printing paper is necessary before an occurrence of a paper-out condition in a copy process using a scanner.

As seen from the above, exemplary embodiments of the present disclosure are described in detail, but the present disclosure is not limited to such specific embodiments, and various modifications and alterations may be made within the gist of the present disclosure as described and claimed herein.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-110669, filed Jun. 8, 2018, which is hereby incorporated by reference herein in its entirety.

What is claimed is:

1. A printing apparatus comprising:
a scanner configured to read a plurality of originals;
a printer configured to start to print images of the originals read by the scanner before the reading of the plurality of originals is completed;
a controller configured to select, from a plurality of printing paper holding units of the printing apparatus, a printing paper holding unit storing printing paper sheets on which the images are to be formed; and
a display configured to display an error message in a case where the number of the printing paper sheets held in the selected printing paper holding unit is less than a number of the printing paper sheets necessary to complete the printing of the images of the plurality of read originals.

2. The printing apparatus according to claim 1, further comprising a user interface configured to allow a user to input an instruction in response to a message displayed on the display,
wherein, in a case where the display displays the error message, the user interface is configured to receive either an instruction for interrupting a printing process to allow the user to perform a replenishment of printing paper or an instruction for continuing the printing process.

3. The printing apparatus according to claim 2,
wherein the display includes a touch panel configured to display the error message, and
wherein the display also functions as the user interface and is configured to display a screen to input the instruction.

4. The printing apparatus according to claim 1,
wherein the controller is configured to select the plurality of printing paper holding units, and
wherein, in a case where the controller selects the plurality of printing paper holding units, the display compares a total of the numbers of the printing paper sheets held in all of the selected printing paper holding units with the number of the printing paper sheets necessary to complete the printing of the images of the plurality of read originals, and displays the message on the display unit based on a result of the comparison.

5. The printing apparatus according to claim 1,
wherein, at a timing when the reading of the plurality of originals by the scanner is completed and the number of the printing paper sheets necessary to complete the printing of the images of the plurality of originals read by the scanner is determined, the controller compares the determined number of the printing paper sheets with the number of the printing paper sheets held in the selected printing paper holding unit, and
wherein, in a case where the determined number of the printing paper sheets is more than the number of the printing paper sheets held in the selected printing paper holding unit, the display displays the error message.

6. The printing apparatus according to claim 1, wherein the error message includes a message to urge a user to perform a replenishment of printing paper.

7. A control method for a printing apparatus having a scanner, a printer configured to start to print images of the originals read by the scanner before the reading of the plurality of originals is completed, a storage, a controller configured to select, from a plurality of printing paper holding units of the printing apparatus, a printing paper holding unit storing printing paper sheets on which the images are to be formed, and a display, the control method comprising:
reading, via the scanner, a plurality of originals;
keeping track, via the storage, of the numbers of printing paper sheets stored in a plurality of printing paper holding units; and
displaying, via the display, an error message in a case where the number of the printing paper sheets held in the selected printing paper holding unit is less than a number of the printing paper sheets necessary to complete the printing of the images of the plurality of read originals.

8. A non-transitory computer-readable storage medium to store a program to cause a computer to perform a control method for a printing apparatus having a scanner, a printer configured to start to print images of the originals read by the scanner before the reading of the plurality of originals is completed, a storage, a controller configured to select, from a plurality of printing paper holding units of the printing apparatus, a printing paper holding unit storing printing paper sheets on which the images are to be formed, and a display, the control method comprising:
reading, via the scanner, a plurality of originals; and
displaying, via the display, an error message in a case where the number of the printing paper sheets held in the selected printing paper holding unit is less than a number of the printing paper sheets necessary to complete the printing of the images of the plurality of read originals.
